(19) United States
(12) Patent Application Publication
(10) Pub. No.: US 2018/0117963 A1
(43) Pub. Date: May 3, 2018

(54) TROLLEY CART WHEEL ASSEMBLY

(71) Applicants: LI-SHENG CHIEN, TAIPEI CITY (TW); CHIEN-CHANG HO, TEIPEI CITY (TW)

(72) Inventors: LI-SHENG CHIEN, TAIPEI CITY (TW); CHIEN-CHANG HO, TEIPEI CITY (TW)

(21) Appl. No.: 15/336,374

(22) Filed: Oct. 27, 2016

(51) Int. Cl. B60B 33/00

(52) U.S. Cl. CPC B60B 33/0047; B60B 33/006

(57) ABSTRACT

A trolley cart wheel assembly includes a wheel fork formed of two spaced ring-shaped side members respectively having locating holes circumferentially spaced thereon; a wheel disposed between the side members and including an annular base having balls disposed on a circumferential surface thereof in a staggered manner and first locking holes provided on two side walls thereof, a rim covering the balls, a tire covering the rim, and two locating rings disposed on two lateral sides of the annular base to limit the rim between them and being provided with radial notches, such that screws can be extended through the radial notches, the first locking holes and the locating holes to lock the wheel fork, the annular base and the locating rings together; and two wheel covers being provided on respective inner wall surface with axially projected hooks adapted to hook onto inner wall surfaces of the side members.

### FIELD OF THE INVENTION

The present invention relates to a trolley cart wheel assembly, and more particularly, to a trolley cart wheel assembly having balls disposed on an outer circumferential surface of an annular base of a wheel in a staggered manner.

### BACKGROUND OF THE INVENTION

Trolley carts are widely used in many places, including but not limited to street markets, supermarkets, hypermarkets and fish markets. Generally, a wheel assembly for the trolley cart includes a wheel fork, a wheel, two bearings and an axle. The wheel fork includes two symmetrical, downward extended side members, which respectively have an axle hole transversely extended therethrough. The wheel is disposed between the two side members and has an axial center being a through hole that extends through two end surfaces of the wheel, and two bearing recesses are formed on the two end surfaces of the wheel. The two bearings are symmetrically mounted in the two bearing recesses and respectively include a bearing hole that is coaxially connected to the central through hole of the wheel. The axle extends through the axle holes on the wheel fork and the central through hole of the wheel to tightly fit in the bearing holes. In this manner, the wheel can rotate about the axle with the help of the bearings, enabling the trolley cart to move.

However, the axle extended through the wheel will bear greater force when the trolley cart carries relatively heavy things. Under this condition, the axle tends to break after being used over a long time.

It is therefore tried by the inventor to develop a trolley cart wheel assembly that does not require an axle to extend through the wheel and can support a greater load.

### SUMMARY OF THE INVENTION

A primary object of the present invention is to provide a trolley cart wheel assembly having a annular annular base, on a circumferential surface of which balls are arranged in a staggered manner, enabling the use of balls having a larger diameter to support a greater load.

Another object of the present invention is to provide a trolley cart wheel assembly that can be screwed to any type of trolley cart.

To achieve the above and other objects, the trolley cart wheel assembly provided according to the present invention includes a wheel fork, a wheel and two wheel covers. The wheel fork is formed of two symmetrical, substantially ring-shaped hollow side members, which are connected at respective upper end via a connecting section having a predetermined width, such that a space is defined by the width of the connecting section between the two side members to separate them from each other. Each of the side members has a plurality of locating holes and a plurality of inner notches circumferentially spaced thereon. The wheel is disposed in the space defined between the two side members of the wheel fork and includes an annular base, a plurality of balls, a rim, a tire and two locating rings. The annular base has a plurality of hemispherical recesses provided on a circumferential surface thereof in a staggered manner, as well as a plurality of first locking holes provided on two side walls thereof. The balls are correspondingly disposed in the hemispherical recesses. The rim is a hollow ring-shaped structure for covering the balls disposed on the circumferential surface of the annular base. The tire is a hollow ring-shaped structure for covering an outer circumferential surface of the rim. One of the locating rings is disposed on a lateral side of the annular base and the other locating ring is disposed on another lateral side of the annular base to limit the rim between the two locating rings. The locating rings are provided on respective inner circumferential edge with a plurality of radial notches, which are located corresponding to the first locking holes on the annular base and the locating holes on the wheel fork, such that screws can be extended through the radial notches, the first locking holes and the locating holes to lock the wheel fork, the annular base and the locating rings together. The two wheel covers are provided on respective inner wall surface with a plurality of axially projected hooks, which are located corresponding to the inner notches on the wheel fork and adapted to hook onto inner wall surfaces of the side members of the wheel fork.

According to an embodiment of the present invention, the annular base further has a plurality of locating recesses, a plurality of second locking holes, and a plurality of retaining recesses formed on the two side walls of the annular base.

According to an embodiment of the present invention, the locating rings are further provided on respective inner circumferential edge with a plurality of radial protrusions, and the radial protrusions are aligned and engaged with the locating recesses on the annular base.

According to an embodiment of the present invention, the wheel covers are further provided on respective inner wall surface with a plurality of raised sections. The raised sections are tightly fitted and retained in the second locking holes, and the projected hooks are located corresponding to the inner notches on the wheel fork and are adapted to hook onto the inner wall surfaces of the side members of the wheel fork and press against the retaining recesses on the annular base.

According to an embodiment of the present invention, the connecting section of the wheel fork has a swivel joint provided thereon with a shaft bolt being fixedly connected to an end of the swivel joint.

According to an embodiment of the present invention, the shaft bolt has external threads formed thereon.

In the present invention, with the balls being arranged on the circumferential surface of the annular base in the staggered manner, it is possible to use balls of a larger diameter to bear higher pressure and allow the trolley cart wheel assembly to support a greater load. Further, by providing the externally threaded shaft bolt on the top of the wheel fork, the trolley cart wheel assembly of the present invention can be assembled to any trolley cart that has threaded holes meshing with the threads on the shaft bolt.

### BRIEF DESCRIPTION OF THE DRAWINGS

The structure and the technical means adopted by the present invention to achieve the above and other objects can be best understood by referring to the following detailed description of the preferred embodiment and the accompanying drawings, wherein

FIG. 1 is an exploded perspective view of a trolley cart wheel assembly according to a preferred embodiment of the present invention;

FIG. 2 is a first partially assembled view of the trolley cart wheel assembly of FIG. 1;

FIG. 3 is a second partially assembled view of the trolley cart wheel assembly of FIG. 1;

FIG. 4 is a third partially assembled view of the trolley cart wheel assembly of FIG. 1;

FIG. 5 is a fourth partially assembled view of the trolley cart wheel assembly of FIG. 1; and

FIG. 6 is a fully assembled view of the trolley cart wheel assembly of FIG. 1.

### DETAILED DESCRIPTION OF THE PREFERRED EMBODIMENTS

The present invention will now be described with a preferred embodiment thereof and by referring to the accompanying drawings.

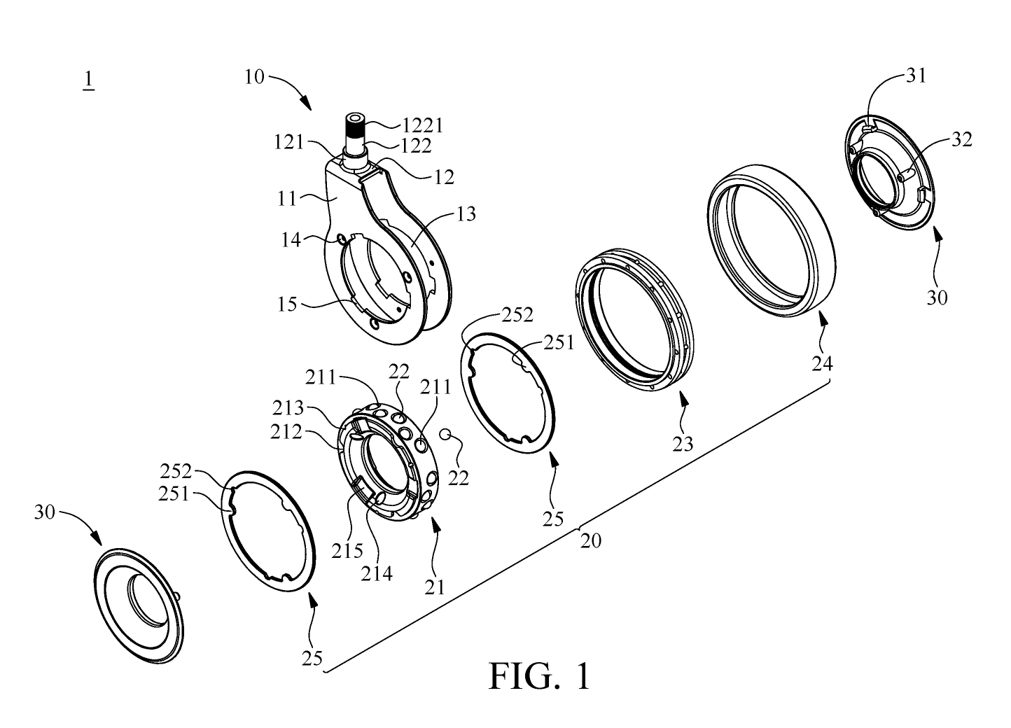

Please refer to FIG. 1 that is an exploded perspective view of a trolley cart wheel assembly 1 according to a preferred embodiment of the present invention. As shown, the trolley cart wheel assembly 1 includes a wheel fork 10, a wheel 20 and a pair of wheel covers 30.

The wheel fork 10 is formed of two symmetrical, substantially ring-shaped hollow side members 11. A connecting section 12 having a predetermined width is transversely extended between and connected to two upper ends of the two side members 11, such that a space 13 is defined by the width of the connecting section 12 between the two side members 11 to separate them from each other and the wheel 20 can be received in the space 13. A plurality of locating holes 14 and a plurality of inner notches 15 are circumferentially spaced on each of the ring-shaped side members 11.

The wheel 20 is disposed in the space 13 and includes an annular base 21, a plurality of balls 22, a rim 23, a tire 24 and two locating rings 25.

The annular base 21 is provided on a circumferential surface thereof with a plurality of hemispherical recesses 211 arranged in a staggered manner, and on each of two side walls thereof with a plurality of locating recesses 212, a plurality of first locking holes 213, a plurality of second locking holes 214, and a plurality of retaining recesses 215. The balls 22 are disposed in the hemispherical recesses 211. The locating recesses 212 and the first locking holes 213 are respectively semicircular in shape. By arranging the hemispherical recesses 211 on the circumferential surface of the annular base 21 in a staggered manner, the hemispherical recesses 211 can respectively have a larger diameter than if they are not arranged in the staggered manner. Accordingly, the balls 22 for disposing in the hemispherical recesses 211 can also have a larger diameter to support a relatively greater load.

The rim 23 is a hollow ring-shaped structure for covering the balls 22 disposed on the circumferential surface of the annular base 21.

The tire 24 is a hollow ring-shaped structure for covering an outer circumferential surface of the rim 23.

One of the two locating rings 25 is disposed on a lateral side of the annular base 21 and the other locating ring 25 is disposed on another lateral side of the annular base 21 to limit the rim 23 between the two locating rings 25. The locating rings 25 are provided on respective inner circumferential edge with a plurality of radial semicircular protrusions 251 and radial semicircular notches 252. The semicircular protrusions 251 are designed to align and engage with the locating recesses 212 formed on the side walls of the annular base 21, so that the locating rings 25 can be located on the two lateral sides of the annular base 21 without moving. The locating rings 25 respectively have an outer diameter larger than that of the annular base 21 and sized between an inner diameter and an outer diameter of the rim 23. Thus, the locating rings 25 can limit the annular base 21 in the rim 23. The semicircular notches 252 are located corresponding to the first locking holes 213 formed on the side walls of the annular base 21, so that each semicircular notch 252 and its corresponding first locking hole 213 together form a round locking hole.

The wheel covers 30 are respectively a hollow annular member having an axially inward recessed structure. The wheel covers 30 are provided on respective inner wall surface with a plurality of axially projected hooks 31 and a plurality of raised sections 32. The projected hooks 31 are located corresponding to the inner notches 15 on the wheel fork 10 and to the retaining recesses 215 on the annular base 21. The raised sections 32 are located corresponding to the second locking holes 214 on the annular base 21.

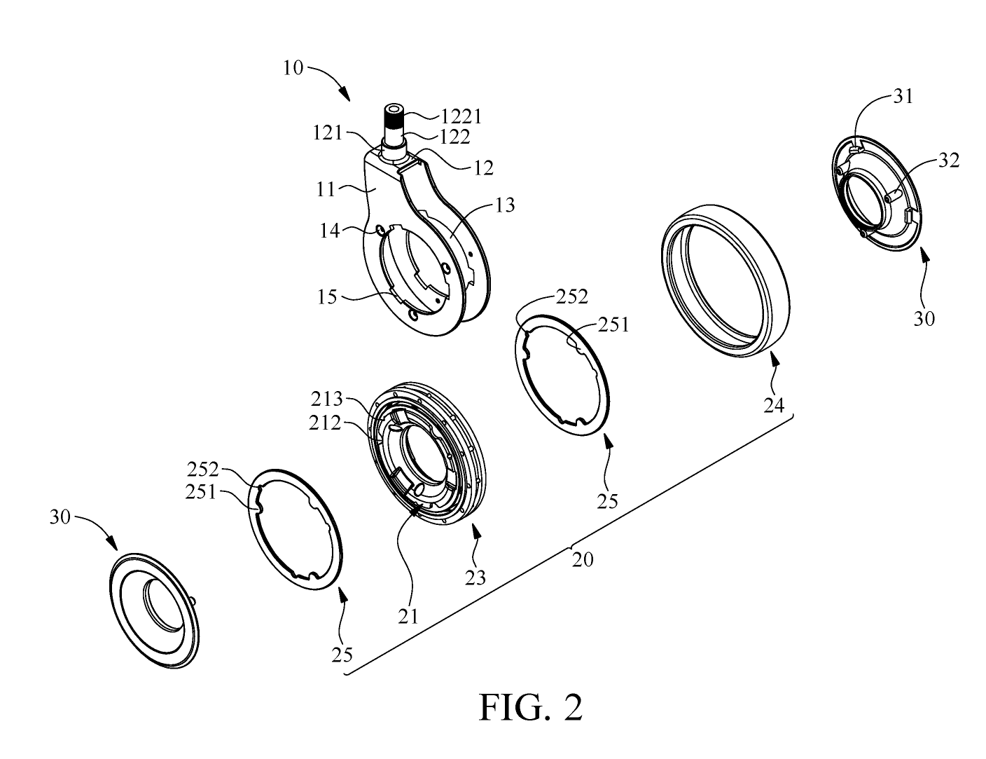

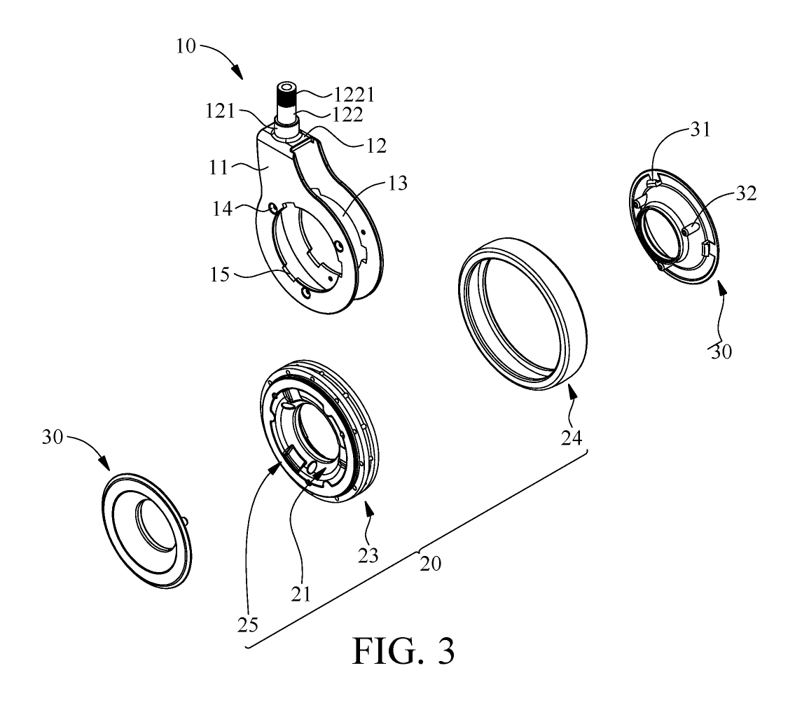

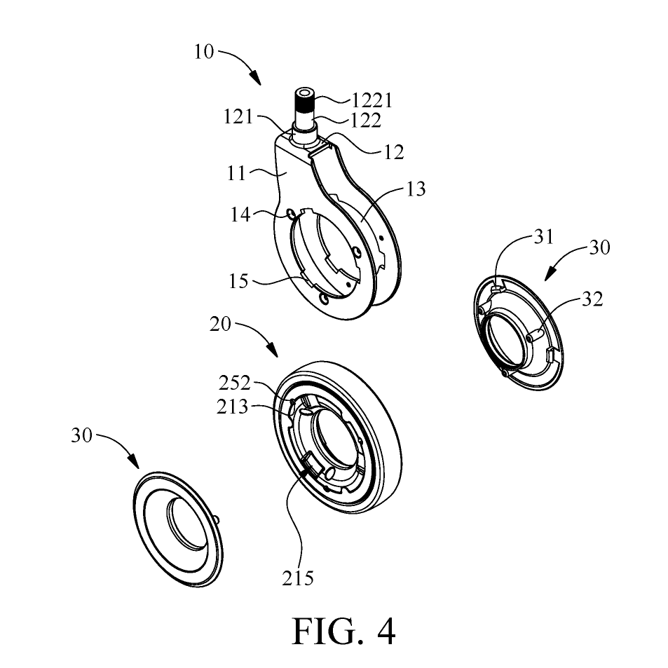

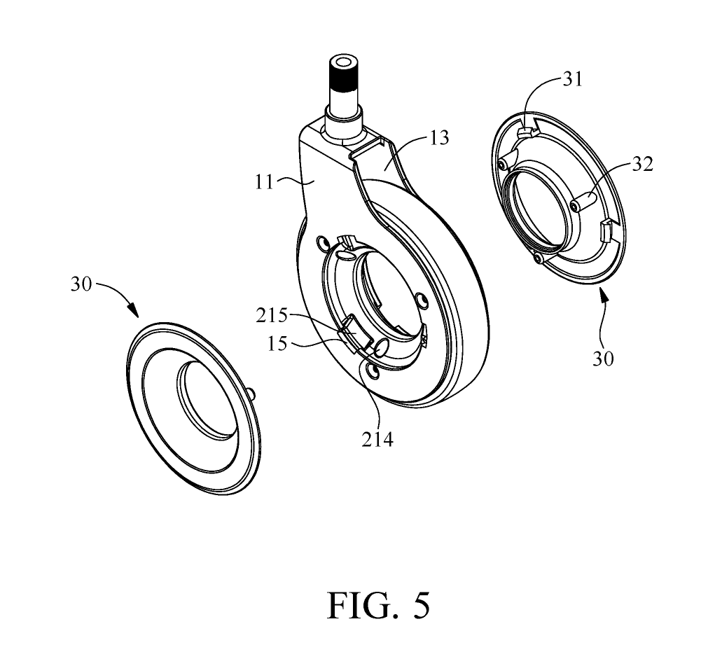

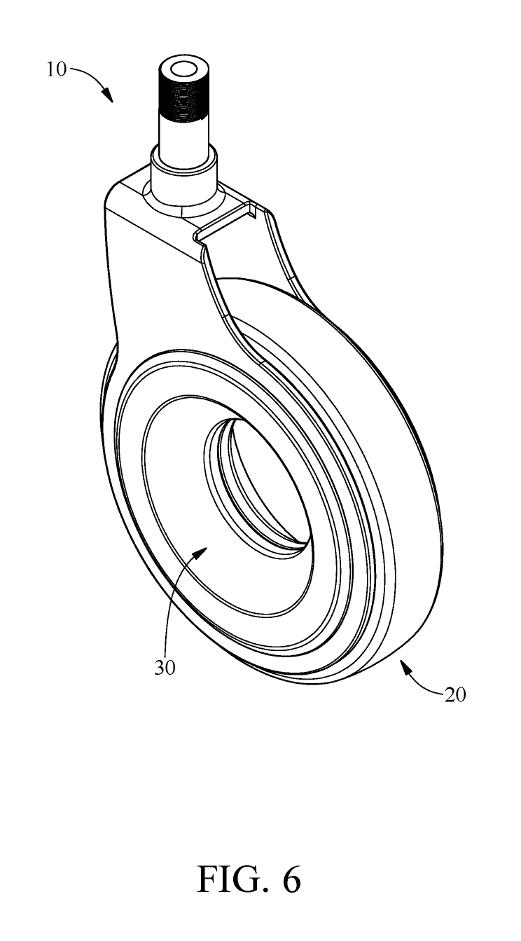

Please refer to FIGS. 2 to 6, which sequentially illustrate how the above-described parts of the trolley cart wheel assembly 1 of the present invention are assembled step by step to provide the complete trolley cart wheel assembly 1.

In a first step, the balls 22 are disposed in the hemispherical recesses 211 formed on the annular base 21 and then, the annular base 21 is fitted in the rim 23. In this manner, a radially distance between the annular base 21 and the rim 23 is equal to a height by which the balls 22 are protruded from the hemispherical recesses 211. When the wheel 20 is pushed, the balls 22 rolling in the hemispherical recesses 211 facilitate easy rotation of the wheel 20.

In a second step, the locating rings 25 are disposed on two lateral sides of the annular base 21, such that the semicircular protrusions 251 on the locating rings 25 are aligned and engaged with the locating recesses 212 formed on the side walls of the annular base 21, bringing the locating rings 25 to be fixedly attached to the two lateral sides of the annular base 21. Meanwhile, the semicircular notches 252 on the locating rings 25 and the first locking holes 213 on the side walls of the annular base 21 are correspondingly located face to face and together form a plurality of round locking holes.

In a third step, the assembled annular base 21, rim 23 and locating rings 25 are together fitted in the tire 24, so that the tire 24 is located around and covers the outer circumferential surface of the rim 23.

In a fourth step, the assembled annular base 21, rim 23, locating rings 25 and tire 24 are positioned in the space 13 between the side members 11 of the wheel fork 10, such that the inner notches 15 on the wheel fork 10 are correspondingly aligned with the retaining recesses 215 on the annular base 21. Meanwhile, the locating holes 14 on the wheel fork 10 are correspondingly aligned with the first locking holes 213 on the annular base 21 and with the semicircular notches 252 on the locating rings 25, allowing a plurality of screws to be extended through the aligned locating holes 14, first locking holes 213 and semicircular notches 252 to lock the wheel fork 10, the annular base 21 and the locating rings 25 together.

In a fifth step, the wheel covers 30 are fitted onto two lateral sides of the wheel fork 10 and the wheel 20 that have been locked together, such that the projected hooks 31 formed on the inner wall surfaces of the wheel covers 30 are aligned with the inner notches 15 on the wheel fork 10 and the retaining recesses 215 on the annular base 21 to hook onto inner wall surfaces of the side members 11 of the wheel fork 10 and press against the retaining recesses 215 on the annular base 21. Meanwhile, the raised sections 32 on the wheel covers 30 are tightly fitted and retained in the second locking holes 214 on the annular base 21. At this point, the trolley cart wheel assembly 1 is fully assembled.

In addition, a swivel joint 121 is provided on the connecting section 12 of the wheel fork 10, and a shaft bolt 122 with external threads 1221 is fixedly connected to an end of the swivel joint 121. With these arrangements, the trolley cart wheel assembly 1 of the present invention can be screwed to any trolley cart that is provided with threaded holes meshing with the external threads 1221 of the shaft bolt 122.

The present invention has been described with a preferred embodiment thereof and it is understood that the preferred embodiment is only illustrative and not intended to limit the present invention in any way and many changes and modifications in the described embodiment can be carried out without departing from the scope and the spirit of the invention that is intended to be limited only by the appended claims.

What is claimed is:

1. A trolley cart wheel assembly, comprising:
a wheel fork formed of two symmetrical, substantially ring-shaped hollow side members; the side members being connected at respective upper end via a connecting section having a predetermined width, such that a space is defined by the width of the connecting section between the two side members to separate them from each other; and each of the side members having a plurality of locating holes and a plurality of inner notches circumferentially spaced thereon;
a wheel disposed in the space defined between the two side members of the wheel fork and including:
an annular base having a plurality of hemispherical recesses provided on a circumferential surface thereof in a staggered manner, as well as a plurality of first locking holes provided on two side walls thereof;
a plurality of balls correspondingly disposed in the hemispherical recesses;
a rim being a ring-shaped hollow structure for covering the balls disposed on the circumferential surface of the annular base;
a tire being a ring-shaped hollow structure for covering an outer circumferential surface of the rim; and
two locating rings; one of the locating rings being disposed on a lateral side of the annular base and the other locating ring being disposed on another lateral side of the annular base to limit the rim between the two locating rings; the locating rings being provided on respective inner circumferential edge with a plurality of radial notches, which are located corresponding to the first locking holes on the annular base and the locating holes on the wheel fork, such that screws can be extended through the radial notches, the first locking holes and the locating holes to lock the wheel fork, the annular base and the locating rings together; and
two wheel covers being provided on respective inner wall surface with a plurality of axially projected hooks; and the axially projected hooks being located corresponding to the inner notches on the wheel fork and adapted to hook onto inner wall surfaces of the side members of the wheel fork.

2. The trolley cart wheel assembly as claimed in claim 1, wherein the annular base further has a plurality of locating recesses, a plurality of second locking holes, and a plurality of retaining recesses formed on the two side walls of the annular base.

3. The trolley cart wheel assembly as claimed in claim 2, wherein the locating rings are further provided on respective inner circumferential edge with a plurality of radial protrusions; and the radial protrusions being aligned and engaged with the locating recesses on the annular base.

4. The trolley cart wheel assembly as claimed in claim 2, wherein the wheel covers are further provided on respective inner wall surface with a plurality of raised sections; the raised sections being tightly fitted and retained in the second locking holes on the annular base; and the projected hooks being located corresponding to the inner notches on the wheel fork and adapted to hook onto the inner wall surfaces of the side members of the wheel fork and press against the retaining recesses on the annular base.

5. The trolley cart wheel assembly as claimed in claim 1, wherein the connecting section of the wheel fork has a swivel joint provided thereon with a shaft bolt being fixedly connected to an end of the swivel joint.

6. The trolley cart wheel assembly as claimed in claim 5, wherein the shaft bolt has external threads formed thereon.
